(19) United States
(12) Patent Application Publication
(10) Pub. No.: US 2003/0027590 A1
(43) Pub. Date: Feb. 6, 2003

(54) Mobile radio terminal device

(76) Inventors: Yutaka Nakamura, Kokubunji-shi (JP); Noboru Koike, Tama-shi (JP); Hirokazu Seraku, Hachioji-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/205,424

(22) Filed: Jul. 26, 2002

(30) Foreign Application Priority Data
Jul. 27, 2001 (JP) 2001-228349

(51) Int. Cl. H04B 1/38; H04M 1/00

(52) U.S. Cl. 455/550; 455/575; 455/90

(57) ABSTRACT

A mobile radio terminal device is of such a double-backing type as to connect an upper casing and lower casing to each other by a hinge. The lower casing includes an input section and a battery. The upper casing includes an antenna, a circuit board having a CPU, a semiconductor memory and a radio circuit, and an interface connectable to various kinds of devices including an external antenna. By a connection line pattern of the circuit board, the antenna and interface are connected to the radio circuit.

### CROSS-REFERENCE TO RELATED APPLICATIONS

This application is based upon and claims the benefit of priority from the prior Japanese Patent Application No. 2001-228349, filed Jul. 27, 2001, the entire contents of which are incorporated herein by reference.

### BACKGROUND OF THE INVENTION

1. Field of the Invention

The present invention relates to a mobile radio terminal device for use in a mobile communication system such as a cellular phone system.

2. Description of the Related Art

As well known in this field, there is a folding type mobile radio terminal device as a mobile radio terminal device for use in a mobile communication system, for example, which is employed in a cellular phone system and so on.

FIGS. 8 to 10 shows such a structure.

FIG. 8 is a front-side view showing the mobile radio terminal device turned to an open state from its closed state. FIG. 9 is a cross-sectional view, as taken along line A-A in FIG. 8, showing the mobile radio terminal device and FIG. 10 is a cross-sectional view, as taken along line B-B in FIG. 8.

As shown in these Figures, the conventional folding type mobile radio terminal device is of such a type that an upper casing 100a and a lower casing 200a are connected together by a hinge 300a to be swingable through a predetermined angle.

The upper casing 100 includes a retractable antenna 1a, a circuit board 2a, a receiver 3a connected to the circuit board 2a, and an LCD (Liquid Crystal Display) 4a.

A connection line pattern 7a is one kind of a coaxial cable and is provided in the circuit board 2a and connected to the antenna 1a. The connection line pattern 7a is further connected to a circuit board 8a of the lower casing 200a past the hinge 300a.

The lower casing 200a includes the circuit board 8a, an input section 9a such as keys and multi-functional keys, and a battery 10a. An interface 6a is provided at a longitudinal end of the lower casing to allow it to be connected to an external device.

The circuit board 8a is connected to the circuit board 2a by a flat cable (not shown) running past the hinge 300a to provide a circuit section 5a.

The circuit section 5a includes not only a CPU (Central Processing Unit) generally controlling each part of the mobile radio terminal device, a semiconductor memory for storing various kinds of information and so on but also a radio circuit for transmitting and receiving a radio signal through the connection line pattern 7a.

In the conventional mobile radio terminal device thus structured, the coaxial cable (i.e., connection line pattern 7a) passes through the hinge 330a and connects the upper and lower casing. Consequently, the coaxial cable is longer than otherwise. Since the coaxial cable is long, the device may therefore suffer form a signal loss and may adversely influenced by external magnetic waves.

On the other hand, a conventional folding type mobile radio terminal device is also under development and it has a structure as shown in FIGS. 11 to 13.

FIG. 11 is a front-side view showing the mobile radio terminal device turned to an open state from its double-back state. FIG. 12 is a cross-sectional view, as taken alone line A-A in FIG. 11, showing the mobile radio terminal device ad FIG. 13 is a cross-sectional view, as taken along line B-B in FIG. 11.

The conventional folding type mobile radio terminal device shown in these Figures is of such a type that an upper casing 100b and a lower casing 200b are connected together by a hinge 300b to be swingable through a predetermined angle.

The upper casing 100b includes a circuit board 2b, a receiver 3b connected to the circuit board 2b and an LCD (Liquid Crystal Display) 4b.

In the lower casing 200b, an expandable/contractable antenna 1b is provided near the hinge 300b. The lower casing 200b includes an interface 6b at its longitudinal end to allow it to be connected to an external device. The lower casing further includes a circuit board 8b, an input section 9b such as keys and multi-functional keys, and a battery 10b.

A connection line pattern 7b is connected to the antenna 1b and to the circuit board 8b. The connection line pattern is also connected to an antenna connection terminal in the interface 6b.

The circuit board 8b is connected to the circuit board 2b by means of a flat cable (not shown) leading to the hinge 300b, and a circuit section 5b is provided on the circuit board 2b.

The circuit section 5b includes a CPU for generally controlling each part of the mobile radio terminal device and a semiconductor memory for storing various kinds of information and further includes a radio circuit for transmitting and receiving a radio signal via the connection line pattern 7b.

This structure can make shorten the length of the coaxial cable 7b. Since, however, the antenna 1b is provided on the lower casing 200b side, the antenna 1b is liable to be shielded by the hand of the user, thus presenting a new problem of lowering an antenna gain to an extreme extent.

In the conventional mobile radio terminal device, since the length of the coaxial cable for connecting together the antenna and radio circuit is greater, a signal loss occurs in the coaxial cable and the device is liable to be adversely affected by an external electromagnetic wave, or, depending upon the position of the antenna, the antenna is shielded by the hand of the user so that the antenna gain is lowered to an extreme extent.

### BRIEF SUMMARY OF THE INVENTION

The present invention is achieved with the encountered problems in view and the object of the present invention is to provide a mobile radio terminal device of a simpler inner structure capable of alleviating a signal loss resulting from a coaxial cable connecting a radio circuit and antenna, as well as alleviating an adverse effect exerted by an external electromagnetic wave on the device, and capable of achieving a gain of an antenna of its own.

In order to achieve the above-mentioned object of the present invention, the present invention provides a mobile radio terminal device comprising a first casing having a display displaying an image and a second casing having a battery for supplying power, the first and second casings are connected by way of a hinge comprising; an antenna provided in the first casing and configured to receive and transmit radio signals; and a radio communication part provided in the first casing and configured to generate signals to be received and transmitted via the antenna.

In the mobile radio terminal device thus structured, the first casing includes the antenna for use in the radio communication and the radio communication part configured to make the radio communication via the antenna.

In the conventional mobile radio terminal device thus configured, the RF cable that connects the antenna and the radio communication part need not be coupled to the second casing. As a result, it is possible to make the RF cable shorter in length and simpler in structure and to alleviate a signal loss by the RF cable and an adverse effect resulting from an electromagnetic wave. Since the user holds the second casing at a time of use, the antenna is not shielded by the hand of the user, so that the antenna can exhibit a gain of its own.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view for explaining a mobile radio terminal device according to one embodiment of the present invention;

FIG. 2 is a cross-sectional view showing the mobile radio terminal device shown in FIG. 1;

FIG. 3 is a cross-sectional view showing an upper casing of the mobile radio terminal device shown in FIG. 1;

FIG. 4 is a view for explaining a structure on a circuit board which is incorporated in the upper casing of the mobile radio terminal device shown in FIG. 1;

FIG. 5 is a view for explaining a structure of a variant of the mobile radio terminal device according to the present invention;

FIG. 6 is a view showing a cross-sectional view of the mobile radio terminal device shown FIG. 5;

FIG. 7 is a cross-sectional view showing an upper casing of the mobile radio terminal device shown in FIG. 5;

FIG. 8 is a view for explaining a structure of a conventional mobile radio terminal device;

FIG. 9 is a cross-sectional view showing the mobile radio terminal device shown in FIG. 8;

FIG. 10 is a cross-sectional view showing an upper casing of the mobile radio terminal device shown in FIG. 8;

FIG. 11 is a view for explaining a structure of a conventional mobile radio terminal device;

FIG. 12 is a cross-sectional view showing the mobile radio terminal device shown in FIG. 11; and

FIG. 13 is a cross-sectional view showing a lower casing of the mobile radio terminal device.

### DETAILED DESCRIPTION OF THE INVENTION

An explanation will be made below about one embodiment of the present invention by referring to the drawing.

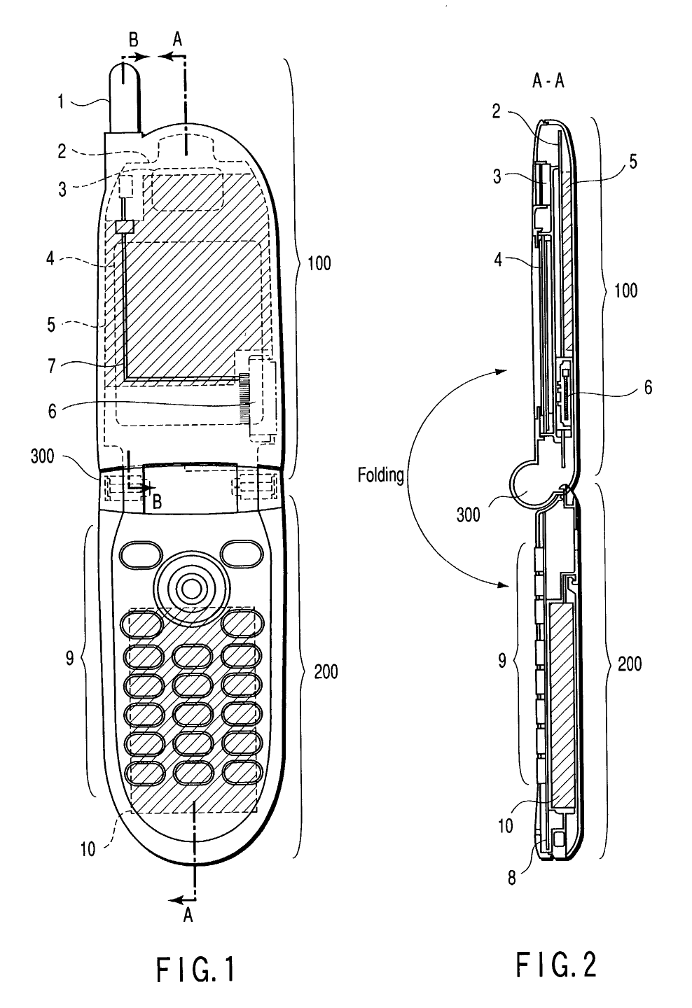

FIGS. 1 to 3 show a structure of a folding type mobile radio terminal device according to one embodiment of the present invention;

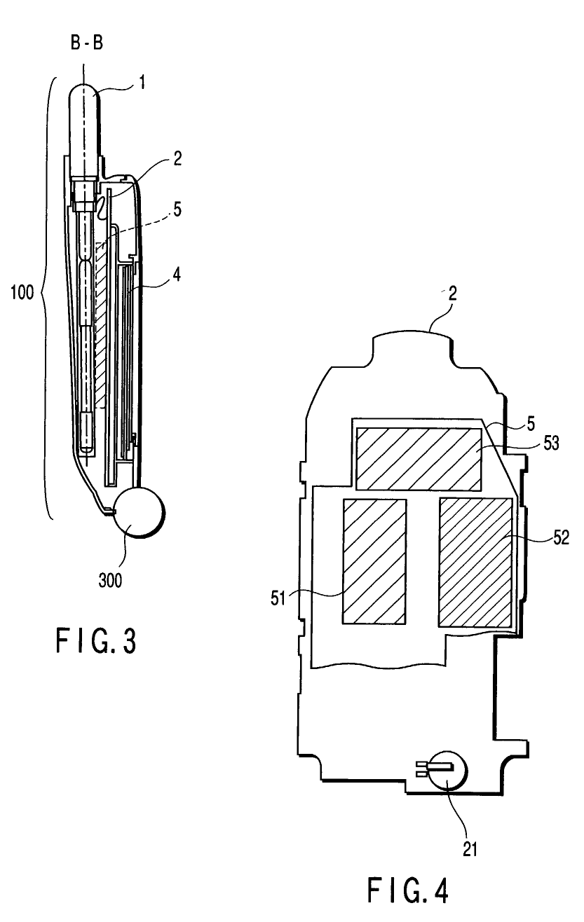

FIG. 1 is a front-side view showing the mobile radio terminal device turned to an open state from its folded-back state. FIG. 2 is a cross-sectional view, as taken along line A-A in FIG. 1, showing the mobile radio terminal device and FIG. 3 is a cross-sectional view, as taken alone line B-B in FIG. 1, showing the mobile radio terminal device.

As shown in these Figures, the mobile radio terminal device is of such a type as to connect together an upper casing 100 and lower casing 200 by means of a hinge 300 to allow them to be swingable through a predetermined angle.

The upper casing 100 includes a retractable antenna 1, a circuit board 2, a receiver 3 connected to the circuit board 2, an LCD (Liquid Crystal Display) 4 and an interface 6 connected to an external device.

The circuit board 2 includes, as shown in FIG. 4, a circuit section 5 and a back-up battery 21.

The circuit section 5 includes a CPU (Central Processing Unit) 51 for generally controlling each part of the mobile radio terminal device and a semiconductor memory 52 for storing various kinds of information, such as control data and telephone directory data, and further includes a radio circuit 53 for transmitting and receiving a radio signal.

The radio circuit 53 is one kind of a coaxial cable and it is connected to the antenna 1 and interface 6 through a connection line pattern 7 of the circuit board 2 and transmits and receives a radio signal through the antenna 1 and interface 6.

The interface 6 includes not only a data communication terminal and a charging terminal but also a terminal for connection to an external antenna. To the latter terminal the connection pattern 7 is connected.

Further, the back-up battery 21 is comprised of a secondary battery using a lithium ion, etc., and protects data stored in the semiconductor memory 52. This battery is charged by a later-described battery 10.

The lower casing 200 includes a circuit board 8, an input section 9 having keys and multi-functional keys, and the battery 10.

The circuit board 8 is connected to the circuit board 2 by a flat cable, not shown, leading to the hinge 300.

As set out above, the above-mentioned mobile radio terminal device is comprised of a folding type structure in which the upper casing 100 and lower casing 200 are connected together by a hinge 300. In this device, the lower casing 200 includes the input section 9 and battery 10 while, on the other hand, the upper casing 100 includes the antenna 1, radio circuit 53 and interface 6.

According to the mobile radio terminal device thus structured, since the connection pattern 7 connecting the antenna 1 and interface 6 to the radio circuit 53 can be made shorter, it is possible to alleviate a signal loss by the connection line pattern 7 and an adverse effect resulting from an external electromagnetic wave.

Further, the connection line pattern 7 can be made shorter in length and simpler in internal structure because it is not passed through the hinge 300.

Further, the antenna 1 is provided at the end of the upper casing 100 and it has less possibility of being shielded by the hand of the user and can exhibit its own gain.

Since the back-up battery 21 is provided at the upper casing 100 side on the same side as that of the semiconductor memory 52, it is possible to retain information in the semiconductor memory 52 even if the upper causing 100 is separated from the lower casing 200 due to a breakage, a repair, etc.

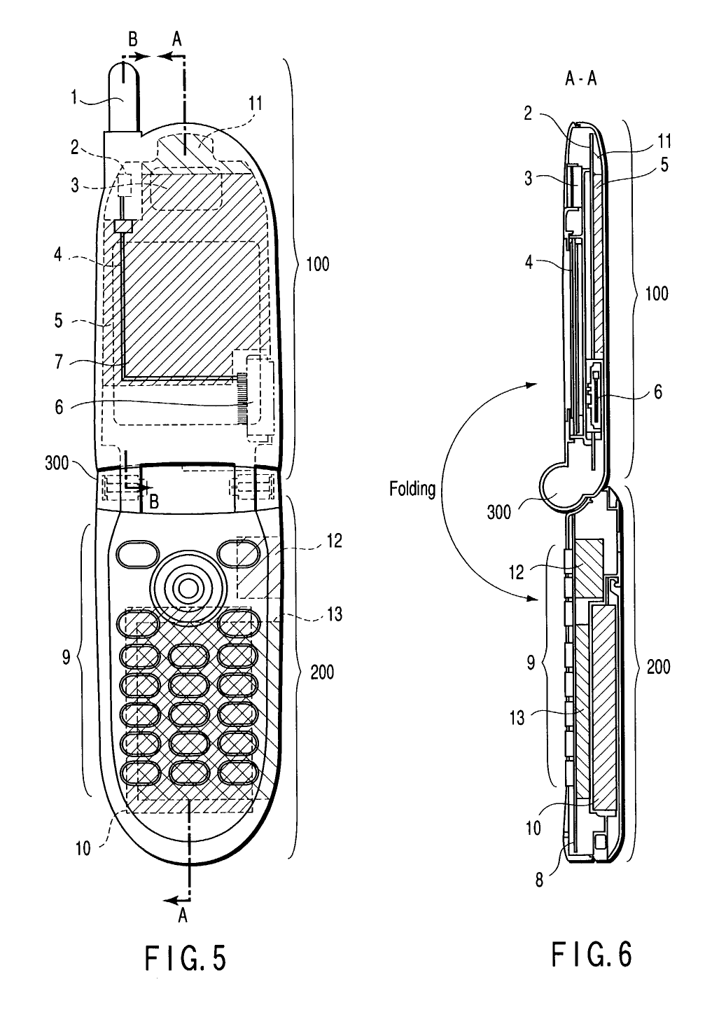

It is to be noted that the present invention is not restricted to the above-mentioned embodiment. For example, it may have a structure as shown, for example, in FIGS. 5 to 7.

FIG. 5 is a front-side view showing a mobile radio terminal device turned to an open state from its closed state.

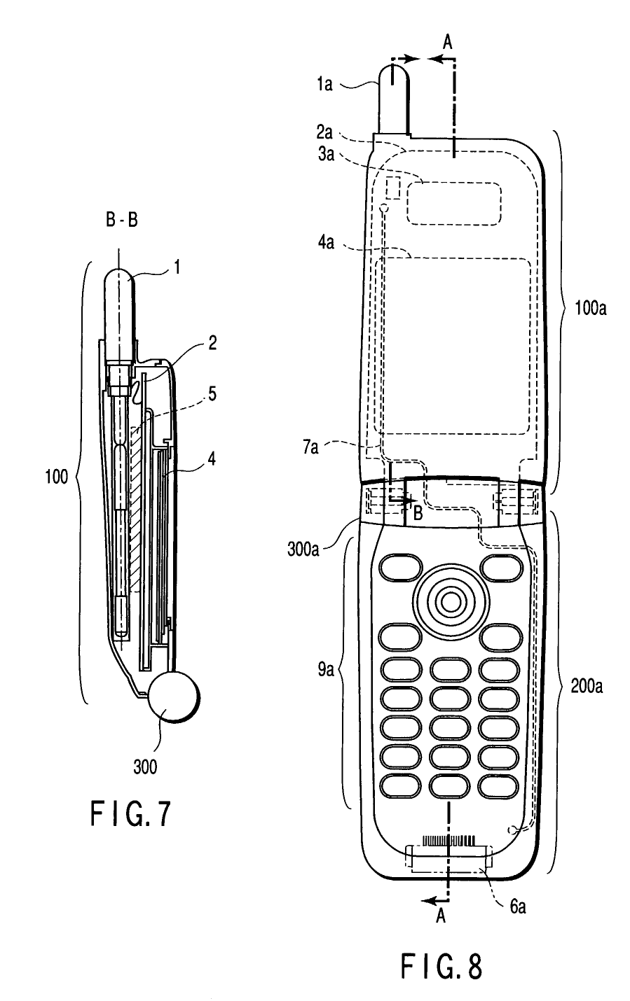

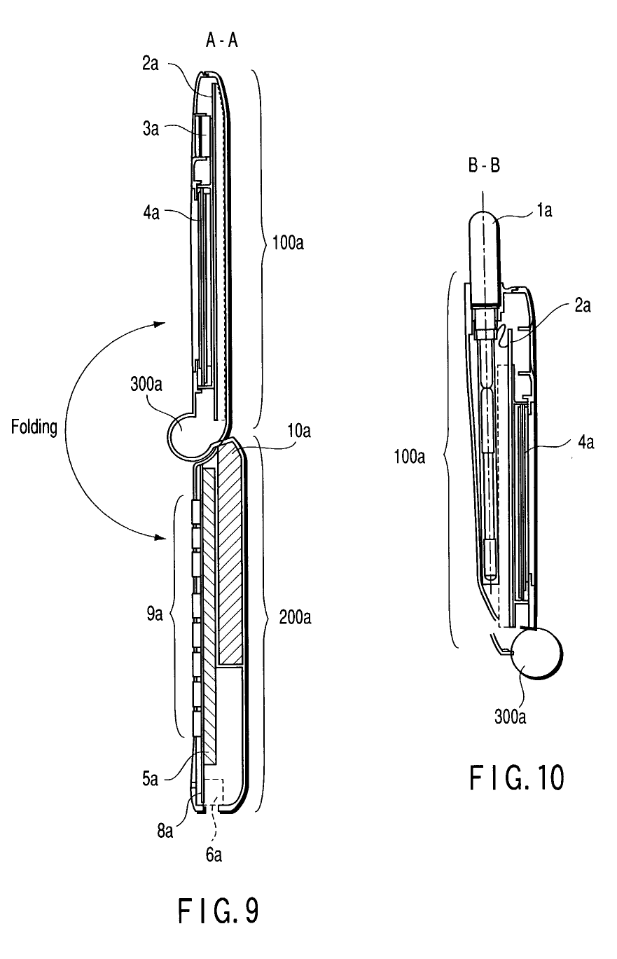

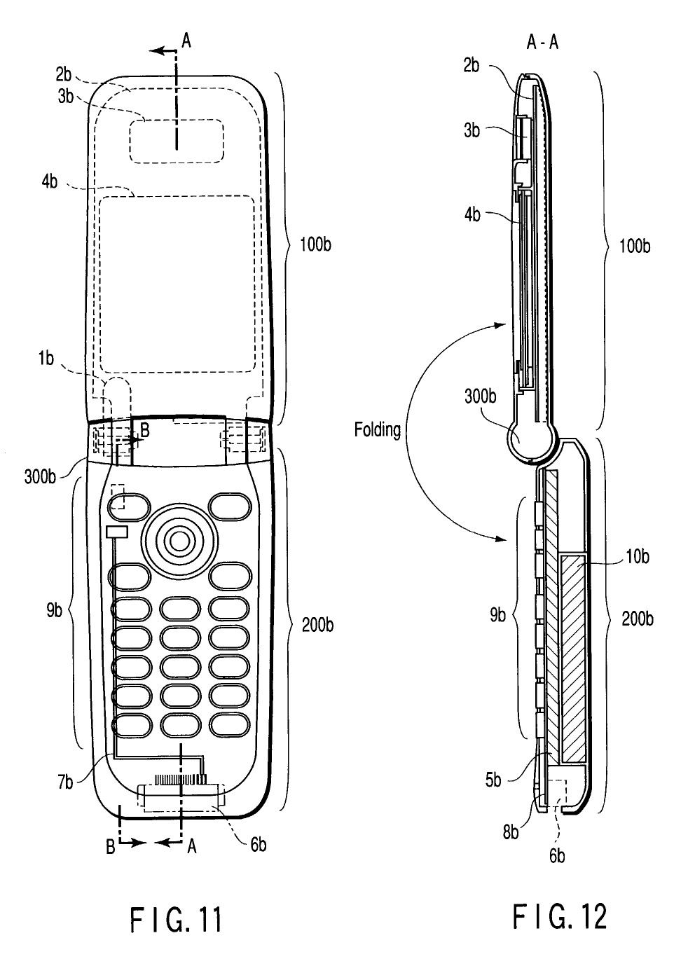

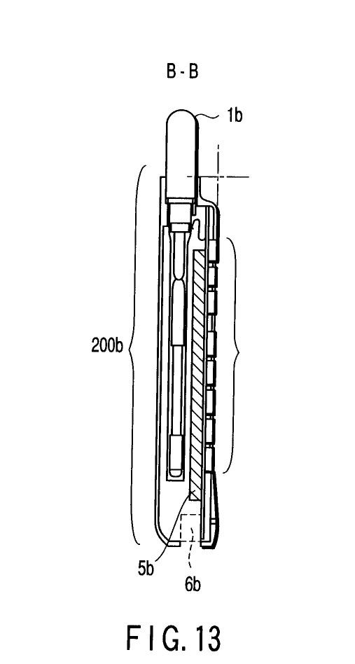

FIG. 6 is a cross-sectional view, as taken along line A-A in FIG. 5, showing the mobile radio terminal device and FIG. 7 is a cross-sectional view, as taken along line B-B in FIG. 5, showing the mobile radio terminal device.

That is, an upper casing 100 may share an antenna 1 and include a GPS receiver 11 for receiving a radio signal from a GPS (Global Positioning System) satellite and a lower casing 200 may include a USB (Universal Serial Bus) interface 12 used for connection to an electronic device, such as a personal computer and a digital camera, and a memory card slot 13 for connection to a memory card for storing mobile communication service authentication data.

Although, in the above-mentioned embodiment, the CPU 51 for controlling each part of the mobile radio terminal device has been explained as being provided in the circuit board 2 on the upper casing 100 side, the present invention is not restricted thereto and the CPU 5 may be provided at the circuit board 8 on the lower casing 200 side.

The present invention can naturally be changed or modified without departing from the scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal device comprising a first casing having a display displaying an image and a second casing having a battery for supplying power, said first and second casings are connected by way of a hinge comprising;
an antenna provided in the first casing and configured to receive and transmit radio signals; and
a radio communication part provided in the first casing and configured to generate signals to be received and transmitted via the antenna.

2. A mobile radio terminal device according to claim 1, wherein the first casing further includes a first connection part configured to make an electrical connection between an external antenna and the radio communication part.

3. A mobile radio terminal device according to claim 1, wherein the first casing further includes a GPS receiving part configured to receive a signal from a GPS (Global Positioning System) satellite.

4. A mobile radio terminal device according to claim 1, wherein the first casing includes a second connection part configured to make a data communication with an outside through an electrical connection.

5. A mobile radio terminal device according to claim 1, wherein the second casing further includes a second connection part configured to make a data communication with a outside through an electrical connection.

6. A mobile radio terminal device according to claim 1, wherein the second casing further allows a third connection part configured to allow a memory medium to be attached and detached and read out information from the memory medium.

7. A mobile radio terminal device according to claim 1, wherein the first casing further includes a memory part configured to store information and a battery for supplying electric power to the memory part to allow the information which is stored in the memory part to be retained.
